(19) United States
(12) Patent Application Publication
(10) Pub. No.: US 2015/0117319 A1
(43) Pub. Date: Apr. 30, 2015

(54) SCHEDULING REQUEST WITHOUT RANDOM ACCESS PROCEDURE

(71) Applicant: QUALCOMM Incorporated, San Diego, CA (US)

(72) Inventors: Ming YANG, San Diego, CA (US); Tom CHIN, San Diego, CA (US); Qingxin CHEN, Del Mar, CA (US); Guangming SHI, San Diego, CA (US)

(73) Assignee: QUALCOMM Incorporated, San Diego, CA (US)

(21) Appl. No.: 14/063,996

(22) Filed: Oct. 25, 2013

(51) Int. Cl. H04W 74/00

(52) U.S. Cl. CPC H04W 74/004
USPC 370/329

(57) ABSTRACT

A method of wireless communication includes transmitting a scheduling request through a common channel without performing a random access procedure, when uplink data remains in a buffer and no active grant exists during a call. The method also includes receiving a grant and initiating data transmission through an enhanced channel.

### TECHNICAL FIELD

Aspects of the present disclosure relate generally to wireless communication systems, and more particularly, to an improved scheduling request that is expedited by skipping a preceding random access procedure.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, High Speed Downlink Packet Access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communications is disclosed. The method includes transmitting a scheduling request through a common channel without performing a random access procedure. The transmitting occurs when uplink data remains in a buffer and no valid grant exists during a call.

Another aspect discloses a method of wireless communications. The method includes monitoring a common channel every potential sub frame for a scheduling request. The method also includes receiving the scheduling request through the common channel without receiving a prior random access request.

In another aspect, a wireless communication apparatus having a memory and at least one processor coupled to the memory is disclosed. The processor(s) is configured to transmit a scheduling request through a common channel without performing a random access procedure. The transmitting occurs when uplink data remains in a buffer and no valid grant exists during a call.

Another aspect discloses a wireless communication apparatus having a memory and at least one processor coupled to the memory. The processor(s) is configured to monitor a common channel every sub frame for a scheduling request. The processor(s) is also configured to receive the scheduling request through the common channel without receiving a prior random access request.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a call flow illustrating a typical scheduling request process.

FIG. 5 is a call flow illustrating a scheduling request process according to aspects of the present disclosure.

FIG. 6 is a block diagram illustrating a wireless communication method for transmitting scheduling requests according to aspects of the present disclosure.

FIG. 7 is a block diagram illustrating a wireless communication method for receiving scheduling requests according to aspects of the present disclosure.

FIG. 8 is a block diagram illustrating an example of a hardware implementation for an apparatus employing a processing system.

FIG. 9 is a block diagram illustrating another example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

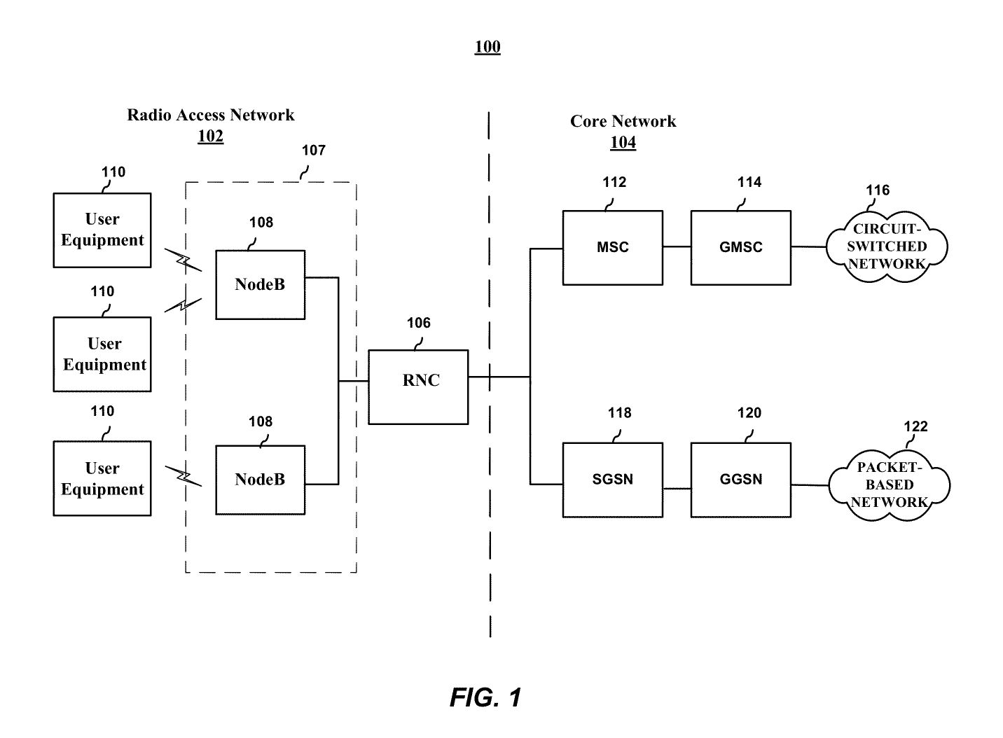

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for general packet radio service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

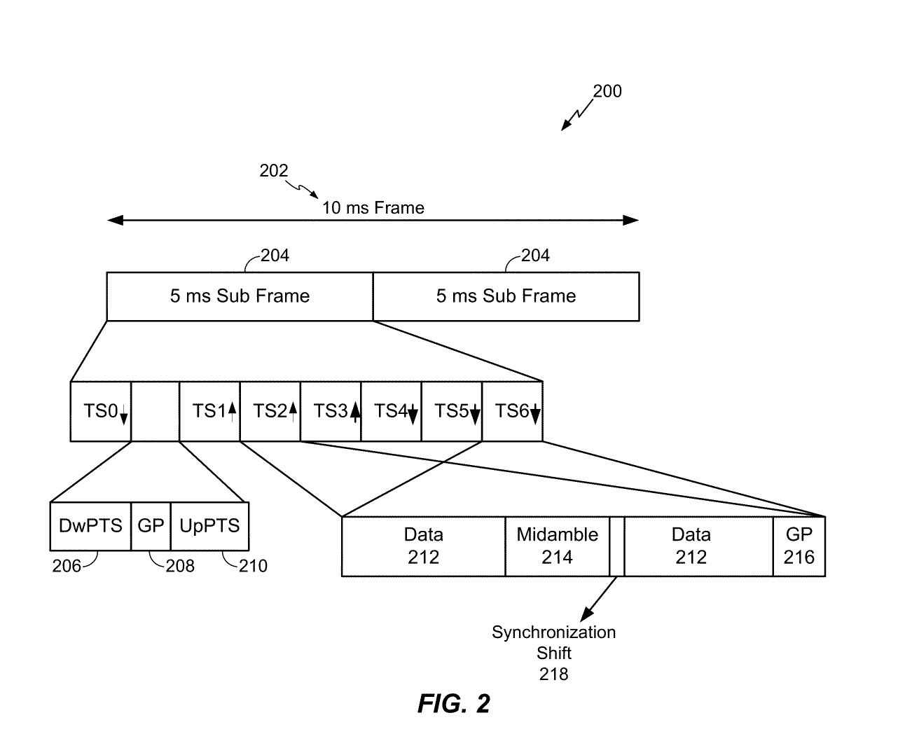

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms sub frames 204, and each of the sub frames 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

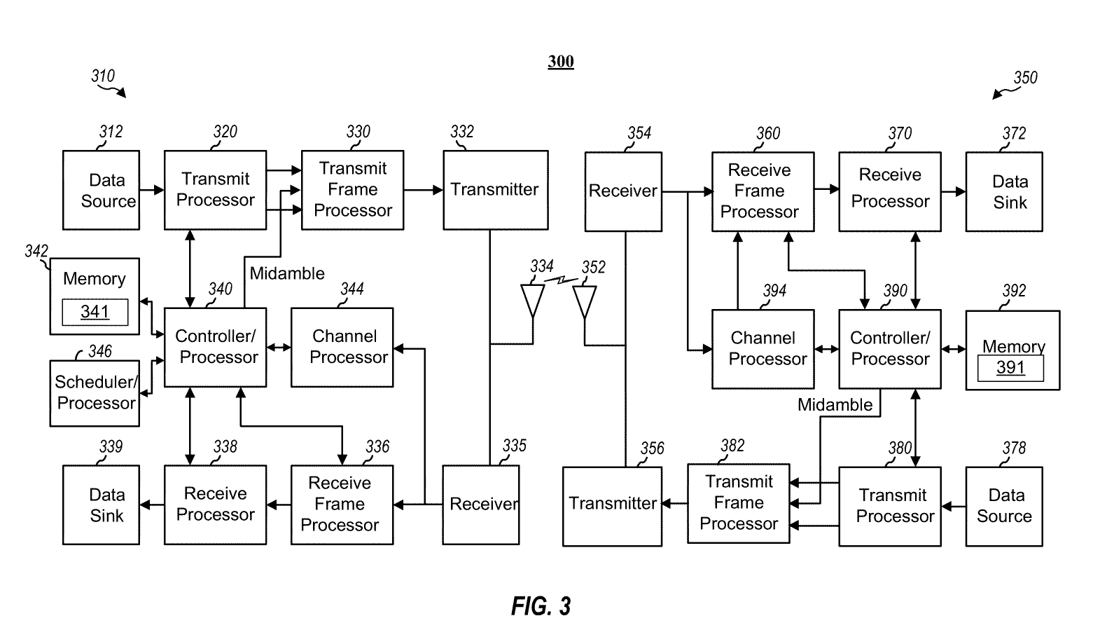

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a scheduling request transmitting module 391 which, when executed by the controller/processor 390, configures the UE 350 to perform a method to transmit a scheduling request. Also, the memory 342 of the node B 310 may store a scheduling request receiving module 341 which, when executed by the controller/processor 340, configures the node B 310 to perform a method to receive a scheduling request. A scheduler/processor 346 at the node B 310 may be used to allocate resources to the UEs and schedule downlink and/or uplink transmissions for the UEs.

High speed uplink packet access (HSUPA) or time division high speed uplink packet access (TD-HSUPA) is a set of enhancements to time division synchronous code division multiple access (TD-SCDMA) in order to improve uplink throughput. In TD-HSUPA, the following physical channels are relevant.

The enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the retransmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels.

The hybrid automatic repeat request (hybrid ARQ or HARQ) indication channel for E-DCH (E-HICH) carries HARQ ACK/NAK signals.

The operation of TD-HSUPA may also have the following steps.

Resource Request: First, the UE sends requests (e.g., via scheduling information (SI)) via the E-PUCH or the E-RUCCH to a base station (e.g., NodeB). The requests are for permission to transmit on the uplink channels.

Resource Allocation: Second, the base station, which controls the uplink radio resources, allocates resources. Resources are allocated in terms of scheduling grants (SGs) to individual UEs based on their requests.

UE Transmission: Third, the UE transmits on the uplink channels after receiving grants from the base station. The UE determines the transmission rate and the corresponding transport format combination (TFC) based on the received grants. The UE may also request additional grants if it has more data to transmit.

Base Station Reception: Fourth, a hybrid automatic repeat request (hybrid ARQ or HARQ) process is employed for the rapid retransmission of erroneously received data packets between the UE and the base station.

The transmission of SI (scheduling information) may consist of two types in TD-HSUPA: (1) In-band and (2) Out-band. For in-band, which may be included in MAC-e PDU (medium access control e-type protocol data unit) on the E-PUCH, data can be sent standalone or may piggyback on a data packet. For Out-band, data may be sent on the E-RUCCH in case that the UE does not have a grant. Otherwise, the grant expires.

Scheduling information (SI) includes the following information or fields.

The highest priority logical channel ID (HLID) field unambiguously identifies the highest priority logical channel with available data. If multiple logical channels exist with the highest priority, the one corresponding to the highest buffer occupancy will be reported.

The total E-DCH buffer status (TEBS) field identifies the total amount of data available across all logical channels for which reporting has been requested by the radio resource control (RRC) and indicates the amount of data in number of bytes that is available for transmission and retransmission in the radio link control (RLC) layer. When the medium access control (MAC) is connected to an acknowledged mode (AM) RLC entity, control protocol data units (PDUs) to be transmitted and RLC PDUs outside the RLC transmission window are also be included in the TEBS. RLC PDUs that have been transmitted but not negatively acknowledged by the peer entity shall not be included in the TEBS. The actual value of TEBS transmitted is one of 31 values that are mapped to a range of number of bytes (e.g., 5 mapping to TEBS, where 24<TEBS<32).

The highest priority logical channel buffer status (HLBS) field indicates the amount of data available from the logical channel identified by HLID, relative to the highest value of the buffer size reported by TEBS. In one configuration, this report is made when the reported TEBS index is not 31, and relative to 50,000 bytes when the reported TEBS index is 31. The values taken by HLBS are one of a set of 16 values that map to a range of percentage values (e.g., 2 maps to 6%<HLBS <8%).

The UE power headroom (UPH) field indicates the ratio of the maximum UE transmission power and the corresponding dedicated physical control channel (DPCCH) code power.

The serving neighbor path loss (SNPL) reports the path loss ratio between the serving cells and the neighboring cells. The base station scheduler incorporates the SNPL for inter-cell interference management tasks to avoid neighbor cell overload.

### Expedited Scheduling Request

Aspects of the disclosure are directed to an improved scheduling request procedure. The improved scheduling request is described with respect to a High Speed Uplink Packet Access (HSUPA) system, such as time division-high speed uplink packet access (TD-HSUPA). Other networks are also contemplated, but to simplify explanation, the description is provided with respect to TD-HSUPA. The improved scheduling request is transmitted on an enhanced uplink dedicated channel (E-DCH) random access uplink control channel (E-RUCCH).

After a radio access bearer (RAB) is established by a wireless communication system, the UE enters a dedicated channel (DCH) state. In the DCH state, the UE first makes a scheduling request through the E-RUCCH. After receiving a grant in response to this scheduling request, the UE can start data transmission through an enhanced physical uplink channel (E-PUCH). Unlike other radio access technologies (RATs) such as W-CDMA, for example, a TD-HSUPA grant has a time duration that lasts for a set number of sub frames. If a grant expires during a data call, the UE may have data in its buffer but no grant. The UE can make a scheduling request through the E-RUCCH to continue or resume the E-PUCH transmission.

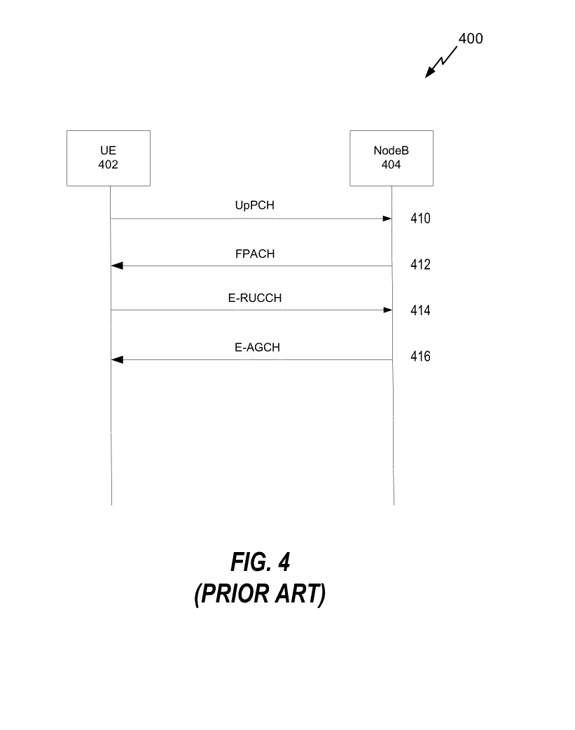

FIG. 4 is a call flow 400 illustrating a scheduling request process using an E-RUCCH. At time 410, a UE 402 chooses and transmits one of N synchronous uplink (SYNC-UL) preamble sequences to a base station (or NodeB) 404 to establish a data call. In one configuration, N is eight (8). The UE 402 sends the SYNC-UL sequence on a selected uplink pilot channel (UpPCH). If the UE 402 does not receive a response (e.g., ACK signal) over a monitored fast physical access channel (FPACH) within a predetermined number of sub frames, then the UE 402 randomly chooses and transmits one of the N SYNC-UL sequences with increased power over a randomly selected UpPCH. In one configuration, the predetermined number of sub frames is four (4). At time 410, the UE 402 may be in a dedicated channel (DCH) state after the establishment of a high speed data connection, i.e., uplink packet access (UPA) radio access bearer (RAB). In FIG. 4, the UE 402 has data but no grant, or a previously received grant expired (because some grants may have a time duration.)

At time 412, once detecting a SYNC_UL sequence, the base station 404 transmits an acknowledgment signal (ACK) as well as uplink transmission power and timing commands in a fast physical access channel (FPACH) message to the UE 402. The uplink transmission power and timing commands may be based on the base station 404 measuring the UpPCH.

At time 414, the UE 402 uses the uplink transmission power and timing commands to transmit a scheduling request to the base station 404 on an enhanced data channel (E-DCH), such as the E-RUCCH. The UE transmits the scheduling request with a UE identification (ID) of an E-DCH radio network temporary identifier (E-RNTI). In addition to the UE ID, the scheduling request may also include the highest priority logical channel ID (HLID), total E-DCH buffer status (TEBS), highest priority logical channel buffer status (HLBS), UE power headroom (UPH) and serving neighbor path loss (SNPL). The base station monitors for E-RUCCH every potential sub frame for a scheduling request. For example, a UE can send a scheduling request based on its ID. Some UEs may send a scheduling request on sub frame 5 based on their UE ID, and yet other UEs may send a scheduling request on sub frame 7, and so on. If there is no other UE, then the base station simply monitors, for example, sub frames 5 and 7 every 16 sub frames.

At time 416, the base station 404 transmits a grant for enhanced physical uplink channel (E-PUCH) transmission over the enhanced access grant channel (E-AGCH). If the UE 402 receives the grant, then it starts E-PUCH transmission. If the UE 402 does not receive the grant during a time period indicated by the network, then the UE 402 repeats the process starting from time 410.

According to an aspect of the present disclosure, the base station monitors the E-RUCCH every sub frame. The E-RUCCH transmission occurs when uplink data remains in a buffer and no active grant exists during the call. The UE skips the random access procedure (e.g., bypassing the transactions at times 410-412 in FIG. 4). That is, the UE directly sends a scheduling request using the E-RUCCH on the sub frame related to the UpPCH where the SYNC-UL sequences would have been transmitted. The UE may randomly select a different sub frame to send data over the E-RUCCH based on the UE ID, for example. In the case of collision (if more than one UE sends data on the same sub frame), the UE will perform a random backoff procedure, and send data over the E-RUCCH again on a different sub frame. The timing and transmission power of the E-RUCCH is based on the accurate timing and transmission power of the uplink DPCH. The uplink timing and transmission power for the uplink DPCH can be received over the E-RUCCH as well. The above approach allows the UE to transmit a fast schedule request, which improves throughput and user perception and reception of data.

A scheduling request includes detailed scheduling information (SI) such as the UE ID, highest priority logical channel ID (HLID), total E-DCH buffer status (TEBS), highest priority logical channel buffer status (HLBS), UE power headroom (UPH) or generic power headroom, buffer size, and/or serving neighbor path loss (SNPL). The scheduling information may be included in the padding of the data, for example. The base station then adjusts the grant based on the scheduling request. That is, the adjusted grant may be a grant where a scheduling information resource or parameter or field is adjusted by the base station.

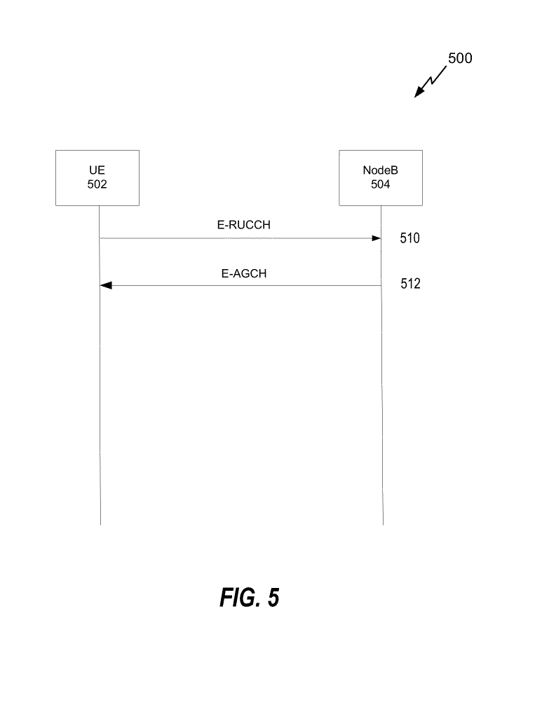

FIG. 5 is a call flow 500 illustrating a scheduling request process according to aspects of the present disclosure. At time 510, the UE 502 transmits a scheduling request over the E-RUCCH. The scheduling request includes a UE identification (ID), as well as E-RUCCH timing commands and transmission power based on an uplink dedicated physical channel (DPCH). That is, the timing commands and transmission power of the E-RUCCH is based on the accurate timing commands and transmission power assigned to the uplink DPCH.

In one configuration, the transmission of the scheduling request may occur in a randomly selected sub frame. The UE 502 skips the typical random access procedure (e.g., bypassing times 410-412 in FIG. 4), and directly sends a scheduling request over the E-RUCCH on the sub frame related to the UpPCH. This process occurs, when uplink data remains in a buffer and no active grant exists. An active grant is non-existent when a previously received grant expires or no grant is received.

In one configuration, the UE 502 will perform a random backoff procedure in the case of collision or in the case that no response is received by the UE 502 from the base station 504 after a predetermined period. In either case, the scheduling request will be retransmitted by the UE 502 a random time delay later, over the E-RUCCH. At time 510, the UE 502 is in a dedicated channel (DCH) state after the establishment of a high speed data connection (i.e., uplink package access (UPA) radio access bearer (RAB)).

At time 512, the base station 504 transmits a grant to the UE 502 based on the scheduling request sent at time 510. The grant may be transmitted over an enhanced access grant channel (E-AGCH). Once the UE 502 receives the grant, it can initiate high-speed transmission over the E-PUCH.

In one configuration, a scheduling request grant is 23 bits and all of its detailed information (e.g., buffer size, power headroom, serving neighbor path loss (SNPL)) is included in those bits. In one configuration, the UE includes the scheduling request in a data packet sent via the MAC e-PDU on the E-PUCH after the UE receives the grant via the E-AGCH. The UE later receives the grant based on details in the scheduling request such as the buffer size, power headroom, SNPL and so on. The base station scheduler adjusts the grant accordingly for E-PUCH transmission. The above-described approach allows the UE to make a fast scheduling request, which results in improving throughput of the overall system and user reception of data.

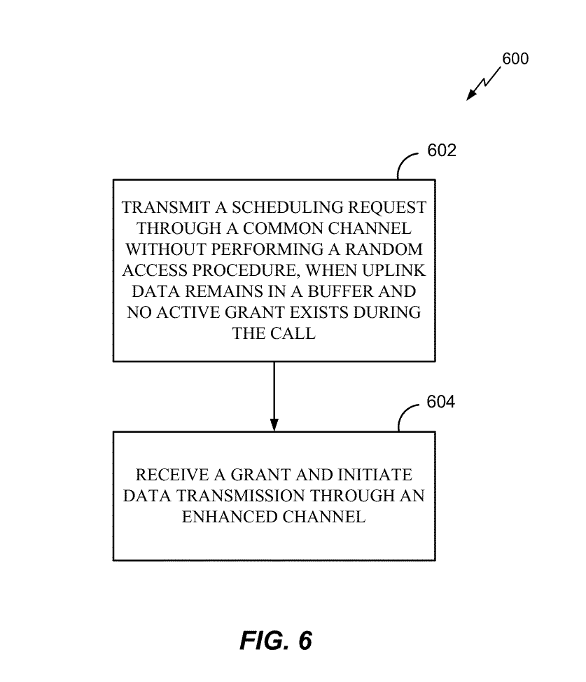

FIG. 6 is a block diagram illustrating a wireless communication method 600 for transmitting scheduling requests according to aspects of the present disclosure. In block 602, a UE transmits a scheduling request through a common channel without performing a random access procedure. The transmission occurs when uplink data remains in a buffer and no active grant exists during the call. In block 604, the UE receives a grant and initiates data transmission through an enhanced channel. In one configuration, the common channel is an enhanced uplink dedicated channel (E-DCH) random access uplink control channel (E-RUCCH). In another configuration, the enhanced channel is an enhanced physical uplink channel (E-PUCH). In yet another configuration, the transmission of the scheduling request includes transmission of at least one timing command and a transmission power assigned to an uplink dedicated physical channel (DPCH). In still another configuration, the transmission may occur in a randomly selected sub frame. In a further configuration, the method 600 may also include retransmitting the scheduling request a random time delay later, when no response is received after a predetermined period.

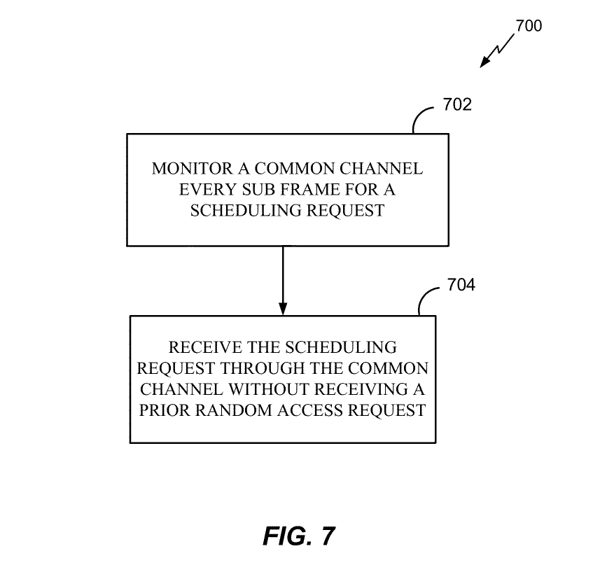

FIG. 7 is a block diagram illustrating another wireless communication method 700 for receiving scheduling requests according to aspects of the present disclosure. In block 702, a base station monitors a common channel every sub frame for a scheduling request. In block 704, the base station receives the scheduling request through the common channel without receiving a prior random access request.

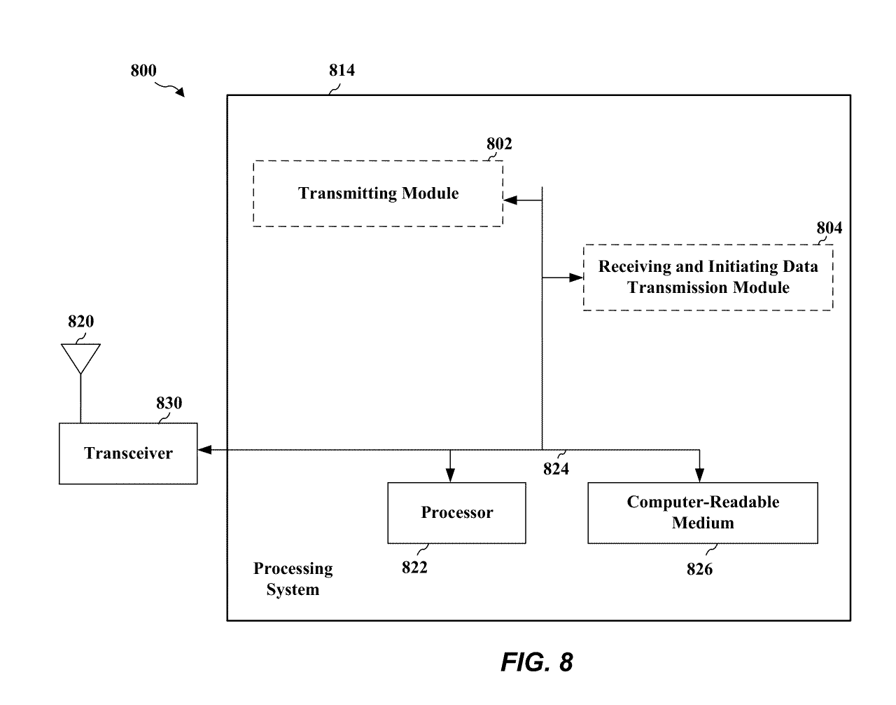

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822, the transmitting module 802, the receiving and initiating data transmission module 804, and the computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a transmitting module 802 for transmitting a scheduling request through a common channel without performing a random access procedure. The transmission occurs when uplink data remains in a buffer and no active grant exists during the call. The processing system 814 also includes a receiving and initiating data transmission module 804 for receiving a grant and initiating data transmission through an enhanced channel. The modules may be software modules running in the processor 822, resident/stored in the computer-readable medium 826, one or more hardware modules coupled to the processor 822, or some combination thereof. The processing system 814 may be a component of the UE 350 and may include the memory 392, and/or the controller/processor 390.

In one configuration, an apparatus such as a UE 350 is configured for wireless communication including means for transmitting. In one aspect, the above means may be the antenna 352, the transmitter 356, the transmit processor 380, the controller/processor 390, the memory 392, the scheduling request transmitting module 391, the transmitting module 802, the processor 822, and/or the processing system 814 configured to perform the functions recited by the aforementioned means. In another aspect, the aforementioned means may be any module or any apparatus configured to perform the functions recited by the aforementioned means.

In one configuration, the apparatus configured for wireless communication also includes means for receiving and initiating data transmission. In one aspect, the above means may be the antenna 352, the receiver 354, the receive processor 370, the controller/processor 390, the memory 392, the scheduling request transmitting module 391, the receiving and initiating data transmission module 804, the processor 822, and/or the processing system 814 configured to perform the functions recited by the aforementioned means. In another aspect, the aforementioned means may be any module or any apparatus configured to perform the functions recited by the aforementioned means.

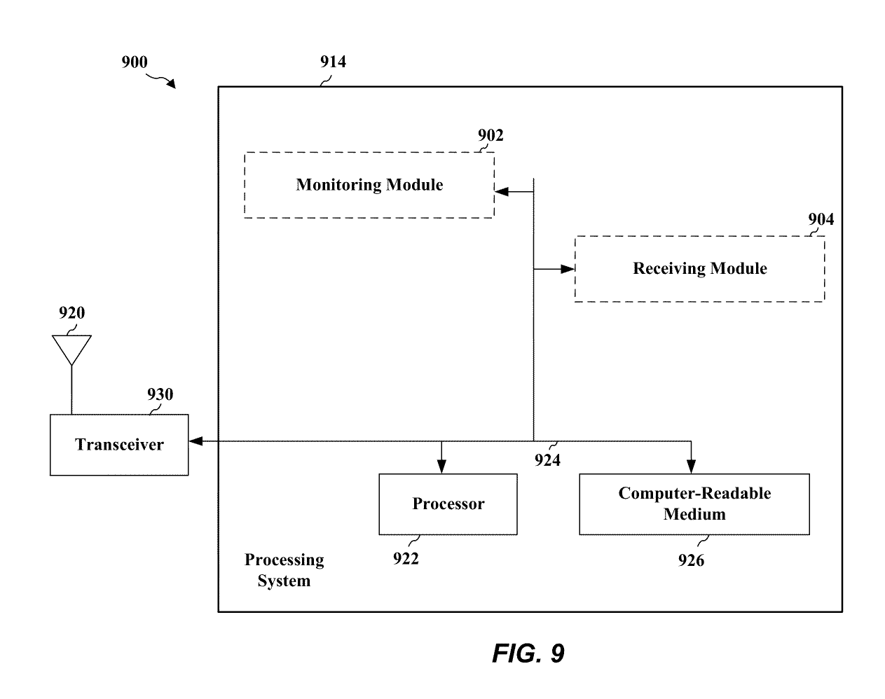

FIG. 9 is a diagram illustrating an example of a hardware implementation for an apparatus 900 employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 922, the monitoring module 902, the receiving module 904, and the computer-readable medium 926. The bus 924 may also link various other circuits such as timing sources, peripherals, voltage regulators, and power management circuits, which are well known in the art, and therefore, will not be described any further.

The apparatus includes a processing system 914 coupled to a transceiver 930. The transceiver 930 is coupled to one or more antennas 920. The transceiver 930 enables communicating with various other apparatus over a transmission medium. The processing system 914 includes a processor 922 coupled to a computer-readable medium 926. The processor 922 is responsible for general processing, including the execution of software stored on the computer-readable medium 926. The software, when executed by the processor 922, causes the processing system 914 to perform the various functions described for any particular apparatus. The computer-readable medium 926 may also be used for storing data that is manipulated by the processor 922 when executing software.

The processing system 914 includes a monitoring module 902 for monitoring a common channel every sub frame for a scheduling request. The processing system 914 also includes a receiving module 904 for receiving the scheduling request through the common channel without receiving a random access request. The modules may be software modules running in the processor 922, resident/stored in the computer-readable medium 926, one or more hardware modules coupled to the processor 922, or some combination thereof. The processing system 914 may be a component of the node B 310 and may include the memory 342, and/or the controller/processor 340.

In one configuration, the apparatus configured for wireless communication includes means for monitoring. In one aspect, the above means may be the antenna 334, the controller/processor 340, the memory 342, the scheduling request receiving module 341, the monitoring module 902, the processor 922, and/or the processing system 914 configured to perform the functions recited by the aforementioned means. In another aspect, the aforementioned means may be a module or any apparatus configured to perform the functions recited by the aforementioned means.

In one configuration, an apparatus such as a node B 310 is configured for wireless communication including means for receiving. In one aspect, the above means may be the antenna 334, the receiver 335, the receive processor 338, the controller/processor 340, the memory 342, the scheduling request receiving module 341, the receiving module 904, the processor 922, and/or the processing system 914 configured to perform the functions recited by the aforementioned means. In another aspect, the aforementioned means may be any module or any apparatus configured to perform the functions recited by the aforementioned means.

Several aspects of a telecommunications system has been presented with reference to TD-SCDMA systems and/or TD-HSUPA. As those skilled in the art will readily appreciate, various aspects described throughout this disclosure may be extended to other telecommunication systems, network architectures and communication standards. By way of example, various aspects may be extended to GSM, as well as UMTS systems such as W-CDMA, high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
transmitting a scheduling request through a common channel without performing a random access procedure, when uplink data remains in a buffer and no valid grant exists during a call.

2. The method of claim 1, in which transmitting the scheduling request comprises transmitting using an uplink transmission timing and an uplink transmission power of an uplink dedicated physical channel (DPCH).

3. The method of claim 1, in which the common channel comprises an Enhanced Uplink Dedicated Channel (E-DCH) Random Access Uplink Control Channel (E-RUCCH).

4. The method of claim 1, in which the transmitting occurs in a randomly selected sub frame based at least in part on an user equipment (UE) identification (ID).

5. The method of claim 1, further comprising retransmitting the scheduling request a random time delay later, when no response is received after a predetermined period.

6. The method of claim 1, in which no valid grant exists when a prior grant expires or no grant is received.

7. A method of wireless communication, comprising:
monitoring a common channel every potential sub frame for a scheduling request; and
receiving the scheduling request through the common channel without receiving a prior random access request.

8. The method of claim 7, in which the scheduling request was transmitted using an uplink transmission timing and an uplink transmission power of an uplink dedicated physical channel (DPCH).

9. The method of claim 7, in which the common channel comprises an Enhanced Uplink Dedicated Channel (E-DCH) Random Access Uplink Control Channel (E-RUCCH).

10. The method of claim 7, further comprising transmitting a grant in response to the scheduling request.

11. An apparatus for wireless communication, comprising:
a memory;
at least one processor coupled to the memory, the at least one processor being configured:
to transmit a scheduling request through a common channel without performing a random access procedure, when uplink data remains in a buffer and no valid grant exists during a call.

12. The apparatus of claim 11, in which the at least one processor is further configured to transmit with an uplink transmission timing and an uplink transmission power of an uplink dedicated physical channel (DPCH).

13. The apparatus of claim 11, in which the common channel comprises an Enhanced Uplink Dedicated Channel (E-DCH) Random Access Uplink Control Channel (E-RUCCH).

14. The apparatus of claim 11, in which the at least one processor is further configured to transmit in a randomly selected sub frame based at least in part on an user equipment (UE) identification (ID).

15. The apparatus of claim 11, in which the at least one processor is further configured to retransmit the scheduling request a random time delay later, when no response is received after a predetermined period.

16. The apparatus of claim 11, in which no valid grant exists when a prior grant expires or no grant is received.

17. An apparatus for wireless communication, comprising:
a memory;
at least one processor coupled to the memory, the at least one processor being configured:
to monitor a common channel every sub frame for a scheduling request; and
to receive the scheduling request through the common channel without receiving a prior random access request.

18. The apparatus of claim 17, in which the scheduling request was transmitted with an uplink timing and a transmission power of an uplink dedicated physical channel (DPCH).

19. The apparatus of claim 17, in which the common channel comprises an Enhanced Uplink Dedicated Channel (E-DCH) Random Access Uplink Control Channel (E-RUCCH).

20. The apparatus of claim 17, in which the at least one processor is further configured to transmit a grant in response to the scheduling request.
